(19) United States
(12) Patent Application Publication
(10) Pub. No.: US 2009/0246078 A1
(43) Pub. Date: Oct. 1, 2009

(54) Electromagnetic Assay

(76) Inventors: Jonathan Dean Barnard, Bedfordshire (GB); Jonathan Johnson, Cambridge (GB)

Correspondence Address: FOLEY HOAG, LLP;PATENT GROUP (w/ISA), 155 SEAPORT BLVD., BOSTON, MA, 02210-2600, US

(21) Appl. No.: 12/281,394

(22) PCT Filed: Mar. 7, 2007
(86) PCT No.: PCT/GB2007/000779

§ 371 Date: Feb. 19, 2009

Related U.S. Application Data
(60) Provisional application No. 60/867,964, filed on Nov. 30, 2006.

(30) Foreign Application Priority Data
Mar. 7, 2006 (GB) 0604608.0

(51) Int. Cl. G01N 31/22

(52) U.S. Cl. 422/56

(57) ABSTRACT

An apparatus includes a sample strip-receiving member configured to receive a sample strip that includes a chamber. The chamber includes a magnetically susceptible particle. The apparatus also includes an electromagnetic field generator configured to subject the magnetically susceptible particle of the chamber of a sample strip received by the sample strip-receiving member to an oscillating magnetic field. The electromagnetic field generator includes first and second coils. The coils are spaced apart along and disposed about a common axis. A detector is configured detect a response to the oscillating magnetic field of the particle of a chamber of a received sample strip. The device can be used to, for example, determine a coagulation parameter of a blood sample.

### RELATED APPLICATIONS

The present application claims priority of UK application no. No.: 0604608.0 filed 7 Mar. 2006 and U.S. provisional application No. 60/867,964, filed 30 Nov. 2006. Each of these applications is incorporated herein in its entirety.

### FIELD OF THE INVENTION

The present invention relates to the determination of a property of a sample (e.g., determination of a coagulation parameter of blood).

### BACKGROUND

Blood coagulation follows a series of biochemical reactions in which fibrinogen forms cross-linked polymeric fibrin. The determination of coagulation parameters can assist the cure, prevention, and monitoring of thrombolic and/or fibrinolytic abnormalities. A commonly used coagulation parameter is the coagulation or prothrombin time (PT) of blood or plasma. The PT is typically expressed as an Internationalised Normalised Ratio (INR). Other coagulation parameters include the degree of platelet aggregation, the rate or amount of clot formation and/or clot dissolution, the time required to form a fibrin clot, the activated partial thromboplastin time (APTT), the activated clotting time (ACT), the protein C activation time (PCAT), the Russell's viper venom time (RVVT) and the thrombin time (TT).

U.S. Pat. No. 5,110,727 describes a method and apparatus for the measurement of clot formation times, clot dissolution times, or clotting parameters. The measurements are performed inducing movement of magnetic particles in a sample being assayed. The movement of the particles is monitored.

The CoaguChek Plus™ coagulation meter has been described as offering patients on oral anticoagulant treatment a simple, fast, and convenient way of directly monitoring their INR results.

### SUMMARY

The present invention relates to the determination of a property of a sample (e.g., determination of a coagulation parameter of blood).

One aspect relates to an apparatus comprising a sample strip receiving member configured to receive a sample strip comprising a chamber, the chamber comprising a magnetically susceptible particle, an electromagnetic field generator configured to subject the magnetically susceptible particle of the chamber of a sample strip received by the sample strip receiving member to an oscillating magnetic field, the electromagnetic field generator comprising first and second coils, the coils being spaced apart along and disposed about a common axis, and a detector configured to detect a response to the oscillating magnetic field of the particle of a chamber of a received sample strip.

Another aspect relates to an apparatus, comprising a sample strip receiving member configured to receive a sample strip comprising a first and second chambers, each chamber comprising a magnetically susceptible particle, an electromagnetic field generator configured to subject the magnetically susceptible particle of the chambers of a sample strip received by the sample strip receiving member to an oscillating magnetic field, the electromagnetic field generator comprising: an elongate metallic member comprising first and second ends, first and second coils, each coil surrounding a different portion of the elongate metallic member, each coil defining a generally tubular wall, a first lateral projection in electromagnetic communication with the first end of the metallic member and extending generally parallel to the metallic member, a first portion of the wall of the first coil being disposed between the first lateral projection and the metallic member, a second lateral projection in electromagnetic communication with the first end of the metallic member and extending generally parallel to the metallic member, a second portion of the wall of the first coil being disposed between the second lateral projection and the metallic member, a third lateral projection in electromagnetic communication with the second end of the metallic member and extending generally parallel to the metallic member, a first portion of the wall of the second coil being disposed between the third lateral projection and the metallic member, a fourth lateral projection in electromagnetic communication with the second end of the metallic member and extending generally parallel to the metallic member, a second portion of the wall of the second coil being disposed between the second lateral projection and the metallic member, a detector configured to detect a response to the oscillating magnetic filed of the particles of the first and second chambers of a received sample strip.

Another aspect relates to an apparatus comprising means to receive a sample strip, the sample strip comprising a chamber comprising a magnetically susceptible particle, means to subject the magnetically susceptible particle of the chamber of a sample strip received by the sample strip receiving member to an oscillating magnetic field, the means comprising first and second coils, the coils being spaced apart along and disposed about a common axis, and means to detect a response to the oscillating magnetic filed of the particle of a received sample strip.

Another aspect relates to an apparatus, comprising a sample strip receiving member configured to receive a sample strip comprising a chamber and a magnetically susceptible particle, an electromagnetic field generator configured to subject the particle to an oscillating magnetic field, an optical detector configured to detect a response of the particle to the magnetic field, the detector comprising a light source configured to illuminate the chamber with light and a light sensitive element configured to simultaneously receive light from each of at least two spaced-apart locations of the chamber, Wherein the amount of light received by the light sensitive element from each location is modified by the presence of the particle in that location, and a processor configured to determine a property of a flowable medium in the chamber based on signals indicative of light received by the light sensitive element.

Another aspect relates to an apparatus, comprising: a coil of electrically conductive material, the coil defining a central axis, a sample strip positioning member, the positioning member configured to position, in a detection position, a sample strip comprising first and second chambers, each of the first and second chambers comprising a magnetically susceptible member, and configured to receive a flowable medium, each response including a translation generally along a respective path, each path being offset from the central axis, an electrical system configured to pass a current through the coil to generate a magnetic field, a detection system configured to detect a response of the member of each of the first and second chambers to the magnetic field, and a processor configured to receive a signal from the detection system, the signal indicative of the motions of the members and to determine a property of the flowable medium of at least one of the members based on the detected motions.

Another aspect relates to an apparatus, comprising a sample strip receiving member configured to receive a sample strip comprising a chamber, the chamber comprising a magnetically susceptible particle, the chamber having a width w and a length l, an electromagnetic field generator configured to subject the magnetically susceptible particle of the chamber of a sample strip received by the sample strip receiving member to an oscillating magnetic field, and a detector configured to detect a response to the oscillating magnetic field of the particle of a chamber of a received sample strip, the detector comprising an optical emitter and an optical collector, the optical emitter configured to emit light into the chamber, the optical emitter having a minimum radial dimension d1, the optical collector configured to receive light from the chamber, the optical collector having a minimum radial dimension d2, wherein (a) a ratio w/d1≦3 and a ratio w/d2≦3 and/or (b) a ratio l/d1≦4.5 and a ratio l/d2≦4.5.

Any of the foregoing apparatus further configured to determine a value indicative of a property of a flowable medium present in the chamber of the sample strip based on the response of the particle(s) to the magnetic field. The flowable medium may be blood and the property of the sample may be a coagulation parameter.

Any of the foregoing apparatus further configured to perform at least one action based on and/or using the value indicative of the property. The at least one action can be selected from the group consisting of storing the value, making the value available for further processing, displaying the at least one value, recording the value, transmitting the value to a remote location, comparing the value to a reference value, displaying information related to the value, or combination thereof.

Any of the foregoing apparatus in which the sample strip receiving member is configured so that the chamber of a received sample strip is disposed between first and second coils. The sample strip receiving member can be configured to receive a sample strip comprising first and second chambers, each chamber comprising a magnetically susceptible particle, the electromagnetic field generator can be configured to subject the respective magnetically susceptible particles of the first and second chambers of a sample strip received by the sample strip receiving member to the oscillating magnetic field, and the detector can be configured to detect the response to the oscillating magnetic field of the respective particles of the first and second chambers of a received sample strip.

The apparatus can further comprising a core member, the core member comprising an axial portion at least partially surrounded by the first coil and first and second lateral projections connected to the axial portion and extending along an exterior of the first coil. The first coil can define a generally tubular wall, a first portion of the wall can be disposed between the axial portion and the first lateral projection and a second portion of the wall can be disposed between the axial portion and the second lateral projection.

The core member may be a first core member and the apparatus can further comprise a second core member, the second core member comprises an axial portion at least partially surrounded by the second coil and first and second lateral projections connected to the axial portion and extending along an exterior of the second coil. The second coil can define a generally tubular wall, a first portion of the wall being disposed between the axial portion and the first lateral projection of the second core member and a second portion of the wall can be disposed between the axial portion and the second lateral projection of the second core member. The axial portions of the first and second core members can form a connected axial member. The axial portions of the first and second core members can extend along the common axis. The first core member may be unitary. The second core member may be unitary. The first and second core members may be a single unitary core member.

The core member of the apparatus may be shaped (e.g., with a slot) to accommodate at least a portion of a sample strip received by the sample strip receiving member. The slot of the core member of the apparatus may be shaped to receive a sample strip along an axis that intersects (e.g., is perpendicular to) a central axis about which the coil(s) are disposed.

The apparatus can be configured to receive a sample strip with the first and second chambers positioned on opposite sides of the common axis and the detector is configured to detect the responses to the oscillating magnetic field of the respective particles of the first and second chambers of a sample strip so received.

Another aspect relates to a method, comprising passing an electrical current through a coil to generate an electromagnetic field, the coil having a central axis, subjecting contents of each of first and second chambers to the magnetic field, the first and second chambers having a respective major axis, the major axis of each of the first and second chambers being offset from the central axis, the contents of each of the first and second chambers comprising a flowable medium and a magnetically susceptible member, and determining a response of the member of each chamber to the magnetic field.

Another aspect relates to a method, comprising passing an electrical current through a coil to generate an electromagnetic field, the coil having a central axis, subjecting contents of each of first and second chambers to the magnetic field, the first and second chambers having a respective major axis, the major axis of each of the first and second chambers being offset from the central axis, the contents of each of the first and second chambers comprising a flowable medium and a magnetically susceptible member, and determining a response of the member of each chamber to the magnetic field.

Another aspect relates to a method, comprising passing an electrical current through a coil to generate a magnetic field, the coil having a central axis, subjecting contents of each of first and second chambers to the magnetic field, the contents of each of the first and second chambers comprising a flowable medium and a magnetically susceptible particle, each particle translating generally along a respective path in response to the magnetic field, each path being offset from the central axis, and determining the respective responses of the particles to the magnetic field.

Any of the foregoing methods can further include determining a value indicative of a property of the flowable medium of at least one of the first and second chambers based on the responses of the members to the magnetic field. The flowable medium can comprise blood and the property may be a coagulation parameter.

Any of the foregoing methods can further comprise performing at least one action based on and/or using the value indicative of the property. The at least one action may be selected from the group consisting of storing the value, making the value available for further processing, displaying the at least one value, recording the value, transmitting the value to a remote location, comparing the value to a reference value, displaying information related to the value, or combination thereof.

In other embodiments, the one or more particles are labelled with a capture agent for an analyte. The analyte to be detected may be any chosen from a biological, industrial, pharmaceutical, agricultural or environmental origin. In particular the analyte may be chosen from a hormone, a marker of cardiac disease or a carbohydrate. The capture agent may be a specific binding reagent that is able to specifically bind with the species of interest to form a specific binding pair. Examples of specific binding pairs include an antibody and antigen where the antigen may be a peptide sequence, complementary nucleotide or peptide sequences, polymeric acids and bases, dyes and protein binders, peptides and specific protein binders, enzymes and cofactors, and effector and receptor molecules, where the term receptor refers to any compound or composition capable or recognising a particular or polar orientation of a molecule, namely an epitopic or determinant site.

The event “coagulation has occurred” may be detected as the situation where two sequential to and fro movements of particles show a difference (for example in duration),

The apparatus may be configured to receive a sample holder between the two coils, whereby the or each particle may translate within the sample holder under the influence of the electromagnetic device.

The distal portions may have bifurcated ends.

The distal portions may have a thickness transverse the common axis that taper from a first thickness of the second portions of the magnetic circuit portions to a distal end region.

The measuring device may have a core member common to said coils for maintaining said coils in said coaxial alignment.

The sample holder may have a predetermined outer profile and the core member defines an aperture having a counterpart profile for engaging the sample holder.

In another aspect here is provided a solenoid having first and second coils arranged on a common axis, a first magnetic circuit portion associated with the first coil and a second magnetic circuit portion associated with the second coil, each magnetic circuit portion having first and second end regions, the first end regions of the first and second magnetic circuit portions defining a first air gap region and the second end regions of the first and second magnetic circuit portions defining a second air gap region, the first and second air gap regions being symmetrically disposed about the common axis, wherein the first and second magnetic circuit portions are substantially identical.

A core member may support the first and second coils and defining the common axis.

The end regions of the magnetic circuit portions may be bifurcated so that each part of the bifurcation may be in close proximity with a sample chamber of a sample holder disposed between the bifurcations.

The end regions may be inwardly directed towards the common axis.

The core member may be a metal bar having respective cylindrical portions supporting the coils, and inwardly tapered regions underlying each end region.

The solenoid may define a passageway for receiving a sample holder having two sample chambers spaced apart by a spacing corresponding to a spacing between the first and second air gap regions, and wherein the spacing enables a sample holder having two sample chambers, the chambers having a longitudinal extent in a first direction, to be inserted so as to create a magnetic flux symmetry across the chambers in at least the said first direction.

In some embodiments, there is provided an electromagnetic assay apparatus comprising an electromagnetic assembly and an optical assembly; wherein the optical assembly comprises at least one light sensitive element (e.g., a photodiode) configured to measure light intensity at each of at least two (e.g., two, three, four) separate positions within a sample chamber.

Such embodiments may reduce signal processing required by a processing circuit.

One or more optical fibres may be used to carry light from each separate location of a sample chamber to the light sensitive element. One or more optical fibres may be used to transfer light from a light source into the sample chamber.

The light sensitive element may include a photodiode. In some embodiments, the light sensitive element includes at least two photodiodes which have been connected to act as a single light sensitive element.

The optical arrangement may be for detecting movement of a particle in the sample chamber.

The light intensity may be the intensity of reflected light. The reflected light may be the light reflected from a surface of the sample chamber opposite the optical assembly. The electromagnetic assembly may be for causing a particle in a sample chamber to move to and fro. The electromagnetic assembly may be for causing a particle in a sample chamber to oscillate.

Embodiments provide an electromagnetic assembly comprising a single piece core element having a plurality of pole components. The pole components may comprise fingers.

Such an embodiment may prevent relative movement of said pole components and thus results in consistent dimensional stability of the electromagnetic assembly. Such an embodiment may prevent relative movement of said pole components and thus results in consistent magnetic fields produced by the electromagnetic assembly.

According to an embodiment, there is provided electromagnetic assay apparatus comprising an electromagnetic assembly that can accommodate both an optical detection apparatus and a heating apparatus.

According to an embodiment, there is provided electromagnetic assay apparatus comprising an electromagnetic assembly arranged to operate on at least one sample chamber position, wherein the electromagnet assembly accommodates both an optical detection apparatus arranged to operate on each sample chamber position and a heating apparatus arranged to operate on each sample chamber position.

The optical detection apparatus and the heating apparatus may be arranged on opposite sides of each sample chamber position. A test strip contains at least one sample chamber. Each sample chamber position may be the position or positions of the at least one sample chamber in the electromagnetic assay apparatus when the test strip is properly inserted into the apparatus.

According to an embodiment, there is provided electromagnetic assay apparatus comprising an electromagnetic assembly having a central pole component and a plurality of finger pole components, the finger pole components arranged substantially at either end of a plurality of sample chamber positions.

Such an electromagnetic assembly reduces magnetic field leakage between pole components adjacent to each sample chamber.

According to an embodiment, there is provided electromagnetic assay apparatus comprising an electromagnetic assembly, a heating assembly and an optical detection assembly, each arranged for interaction with at least one sample chamber position, wherein the electromagnetic assay apparatus is arranged to receive a test strip containing a sample chamber, the electromagnetic assay apparatus further comprising: a sprung plunger for communicating with a locating notch provided on the test strip such that when a test strip is inserted into the device, said sprung plunger communicates with said locating notch to align the test strip with each of the electromagnetic assembly, the heating assembly and the optical detection assembly. The sprung plunger may cause tactile feedback to be provided to a user upon test strip insertion. The sprung plunger may cause the test strip to be removably retained in the apparatus. The sprung plunger may prevent an incorrectly orientated test strip from being fully inserted into the apparatus.

According to an embodiment, there is provided a test strip having a barcode, said barcode suitable for reading by an electromagnetic assay apparatus. According to another embodiment, there is provided an electromagnetic assay apparatus having a barcode reader for reading a barcode on a test strip. The barcode on a test strip may convey information relating to a production batch number of the test strip. A ROM key may be provided with the test strip, the ROM Key readable by a ROM key reader of the device. The ROM key containing data conveying information relating to at least one production batch number. The information conveyed by the ROM key may define one or more characteristics of the test strips associated with the at least one production batch number.

Such embodiments may allow for correction factors stored on a ROM key to be used by the electromagnetic assay apparatus to produce a more accurate test result.

According to an embodiment, there is provided an electromagnetic assay apparatus comprising a heater carrier biased towards a test strip receiving position, said heater carrier having at least one heat transfer block, the heat carrier biased so as to provide a reproducible force between the at least one heat transfer block and the test strip. A heat transfer block may be provided for each sample chamber position, said heat carrier biased so as to produce substantially the same force between each heat transfer block and the test strip. The heat carrier may be biased by a leaf spring.

Such embodiments may provide the same thermal conductivity between each heat transfer block and the test strip.

Unless specified otherwise, a magnetically susceptible particle is a particle capable of being moved (e.g., oscillated) by a magnetic field.

Unless specified otherwise, a “to and fro” motion is an oscillatory motion. The oscillatory motion may be along, for example, a linear or an arcuate path. Unless specified otherwise, the frequency and/or amplitude of the oscillatory motion may vary as a function of time. For example, the frequency and/or amplitude of oscillatory motion of a magnetically susceptible particle through blood present within a chamber of a test strip may change with time (e.g., decrease) as the blood coagulates.

### BRIEF DESCRIPTION OF THE DRAWINGS

FIG. 1 shows a block schematic diagram of a sensing apparatus;

FIG. 2 shows a perspective view of an electromagnetic device for use in a sensing apparatus;

FIG. 3 shows a cross-section through the electromagnetic device of FIG. 2;

FIG. 4 shows magnetic field conditions;

FIG. 5 shows a perspective view of part of a sensing apparatus, showing a sample holder engaged;

FIG. 6 shows an exploded view of some components of a device;

FIG. 7 shows a perspective exploded view of an electromagnetic assembly;

FIGS. 8a, 8b, 8c and 8d show a test strip for use with the device;

FIG. 9a shows an electromagnetic assembly and optical fibres;

FIG. 9b shows a similar arrangement to that of FIG. 9b, but with a test strip inserted;

FIG. 10a shows the arrangement of the optical fibres;

FIG. 10b shows the arrangement of the optical fibres in relation to optical devices;

FIG. 10c shows the arrangement of the optical fibres in a chassis plug assembly;

FIG. 11 shows the magnetic field generated by the electromagnetic assembly;

FIG. 12 shows a start position and a finish position of a particle;

FIG. 12a is a timing diagram for magnetic field and light source switching.

FIG. 12b is a schematic of an electromagnetic field generator and sample strip with chambers.

FIG. 13 shows a heating assembly adjacent to a test strip;

FIG. 14a shows an exploded view of the heating assembly;

FIG. 14b shows a cross section of the heating assembly;

FIG. 15 shows a biasing means;

FIG. 16 shows a latching device;

FIG. 17 shows three relative positions of a sample chamber in relation to a set of four optical fibres, and the optical signal strength for each;

FIG. 18a shows a perspective view of a test strip in position against rear datum;

FIGS. 18b, 18c and 18d show the interaction between the test strip and a latching device;

FIGS. 19a and 19b show a barcode on the test strip; and

FIG. 20 shows an enlarged view of the barcode.

### DETAILED DESCRIPTION

We describe methods and devices for determining a property of a sample. Typically, the sample is combined with at least one magnetically susceptible particle. The particle is subjected to a magnetic field. A response of the particle to the magnetic field is determined. The property of the sample can be determined based on the response of the particle to the magnetic field. In an exemplary embodiment, the sample is a blood-derived fluid (e.g., whole blood) and the property is a coagulation parameter of the blood-derived fluid.

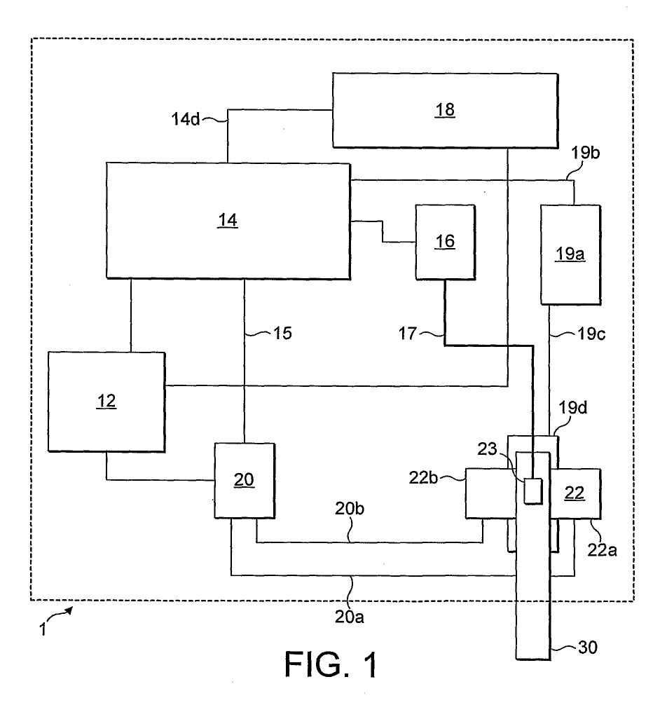

Referring first to FIG. 1, an apparatus 1 for determining a coagulation parameter of blood has an outer casing 10 that houses a battery 12 that provides the power supply for the apparatus. The housing further contains a processing circuit 14, a sensing circuit 16, a display 18, a drive circuit 20, a heater driving circuit 19a, a heating component 19d and an electromagnetic device 22. The processing circuit may be, for example, a microprocessor in use running embedded software. Also shown in FIG. 1 is a sample holder 30 diagrammatically shown as inserted through an opening of the outer casing 10 into cooperation with the electromagnetic device 22.

The sample holder 30 see especially FIG. 4 for an example of a sample holder typically contains 1 or 2 sample chambers 24, and typically has pathways so that blood or other liquids can be introduced into the chambers 24. The chambers 24 contain particles, such as magnetically susceptible particles, that can be moved under the influence of externally applied magnetic fields. In some embodiments, each sample chamber 24 contains a respective single particle.

The particle in this sample holder is a disc (e.g., a particle or a puck 201) of paramagnetic iron. The particle or particles may range in size and shape.

For example, in the determination of coagulation, the particle may be generally disc, puck or rectangular shaped and may vary in size from about 50 μm-2 mm in diameter or length depending upon the dimensions of the fluid chamber. In general, the particle has a minimum radial dimension (e.g., a width or diameter) of at least about 200 μm (e.g., at least about 350 μm, at least about 500 μm). The particle may have a maximum radial dimension (e.g., a length or diameter) of about 2 mm or less (e.g., about 1.5 mm or less, about 1 mm or less, about 750 μm or less). In some embodiments, the maximum and minimum radial dimensions may be identical such as if the particle is disc-like or spherical. The particle typically has a minimum thickness of at least about 25 μm (e.g., at least about 50 μm). The particle typically has a maximum thickness of about 250 μm or less (e.g., about 175 μm or less, about 125 μm or less, about 100 μm or less). In an exemplary embodiment, the particle (e.g., puck) has a diameter of 600 μm and a thickness of 75 μm.

Each surface of the puck 201 may have a non-reflective coating. Such a coating may be vertically non-reflective, such that light incident in a plane perpendicular to the surface is either absorbed or scattered.

The length of the fluid chamber is typically at least about 1 mm long (e.g., at least about 1.25 mm long, at least about 1.5 mm long). The length of the fluid chamber is typically about 2.5 mm or less (e.g., about 2 mm or less, about 1.75 mm or less). The width of the chamber is typically at least about 0.5 mm (e.g., at least about 0.75 mm). The width of the chamber is typically about 1.5 mm or less (e.g., about 1.25 mm or less, about 1 mm or less). The height of the chamber is typically at least about 75 μm (e.g., at least about 125 μm). The height of the chamber is typically about 300 μm or less (e.g., about 250 μm or less about 200 μm or less). In an exemplary embodiment, the chamber has a length of 1.6 mm, a height (i.e., depth) of 175 μm and a width of 1 mm.

In some embodiments, a ratio of the minimum radial dimension (e.g., a width or diameter) of the particle to the width of the chamber is at least about 0.3 (e.g., at least about 0.5). In some embodiments, a ratio of the maximum radial dimension (e.g., a length or diameter) of the particle to the width of the chamber is about 0.9 or less (e.g., about 0.8 or less, about 0.7 or less). In an exemplary embodiment, the ratio is about 0.6.

In some embodiments, a ratio of the minimum radial dimension (e.g., a width or diameter) of the particle to the length of the chamber is at least about 0.25 (e.g., at least about 0.3). In some embodiments, a ratio of the maximum radial dimension (e.g., a length or diameter) of the particle to the length of the chamber is about 0.8 or less (e.g., about 0.65 or less, about 0.5 or less). In an exemplary embodiment, the ratio is about 0.4.

In some embodiments, a ratio of the thickness of the particle to the height of the chamber is at least about 0.25 (e.g., at least about 0.3). In some embodiments, a ratio of the thickness of the particle to the length of the chamber is about 0.8 or less (e.g., about 0.65 or less, about 0.5 or less). In an exemplary embodiment, the ratio is about 0.4. In an alternative embodiment, the puck 201 is steel, and may be CS95. Such a particle may be produced by using double sided etching.

The sample holder is typically disposable and designed to be used in conjunction with the measuring device. It is typically in the form of a test strip 30 and may have a sample inlet port for introducing a fluid sample into the test strip 30, in fluid communication with one, two or more fluid sample chambers.

In some embodiments used for coagulation determination, coagulation promoting reagents are provided within the chamber in order to coagulate the fluid sample. For example, in the determination of a coagulation event, a sample holder may comprise a first test-chamber and a second reference chamber. The first chamber may contain a coagulation promoting reagent and the second chamber may contain no reagent or a reagent designed to cause coagulation within a certain time, or a reagent designed to prevent coagulation taking place. Alternatively, the second chamber may be a test-chamber containing the same coagulation promoting reagent as the first or a different coagulation promoting reagent.

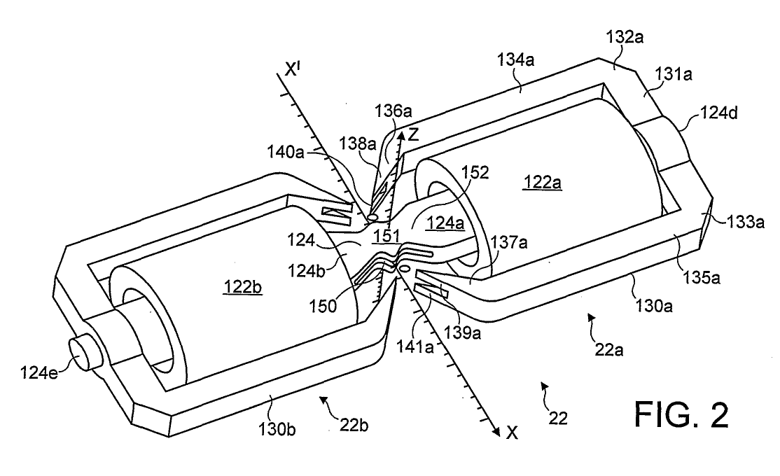

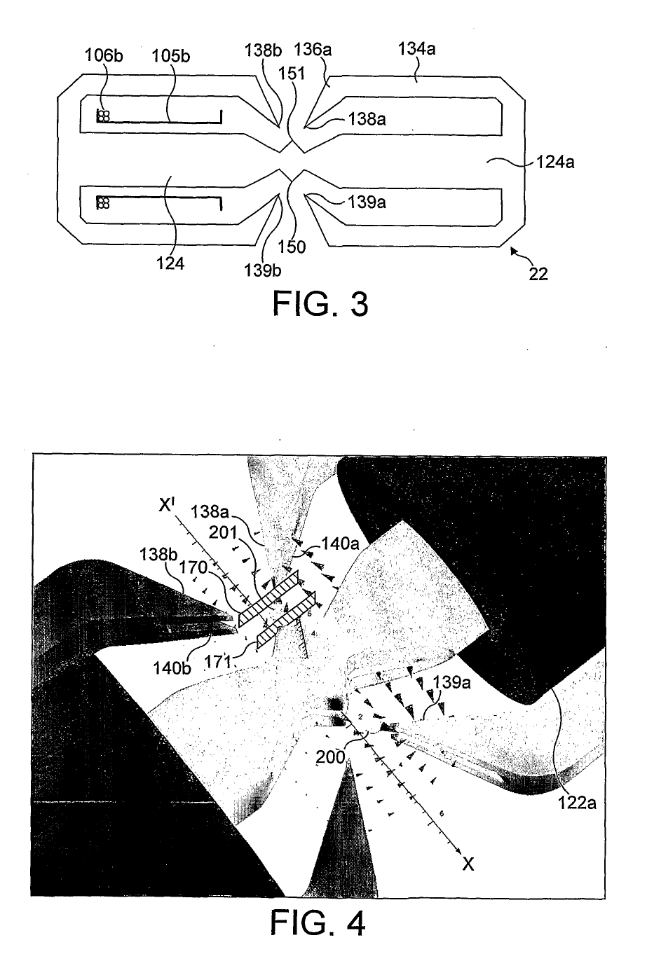

The processing circuit 14 has a control output 15 connected to the drive circuit 20. The electromagnetic device 22, which will be more fully described with respect to FIGS. 2 and 3, has two electromagnetic coils 22a, 22b and the drive circuit 20 has a first output 20a connected to the first electromagnetic coil 22a and a second output 20b connected to the second electromagnetic coil 22b. The processing circuit 14 has a control input 14c that is connected to the sensing circuit 16 and the sensing circuit 16 has a connection 17 to the sensing area 23 associated with the electromagnetic device 22. In the present embodiment the connection 17 consists of an optical fibre link whereby light generated for example by a light-emitting diode in the sensing circuit 16 is applied to the sensing area 23 which coincides with a sample chamber 24 in the sample holder 30. Conditions in the sample chamber 24 are monitored by other optical fibres in the connection 17 and those conditions are conveyed via the connection 17 to the sensing circuit 16. Information representative of the conditions is conveyed via the control input 14c to the processing circuit 14, in use. The processing circuit 14 has an output 14d leading to the display 18 which is typically an LCD display.

The processing circuit 14 has an output 19b connected to heater driving circuit 19a. Heater driving circuit 19a drives a heater 19d via line 19c. Heater 19d is arranged in thermal contact with a sample holder 30.

In operation an “ON” switch (not shown) is operated and the device powers up from the battery 12. When a sample holder 30 is introduced, this is sensed by the processing circuit 14 which provides command signals to heater driving circuit 19a. This causes heater driving circuit 19a to provide power to heater 19d, causing it to heat the sample holder to a predetermined temperature.

Further, upon detection of an inserted sample holder 30, processing circuit 14 provides commands over the line 15 to the drive circuit 20. In response to the commands, the drive circuit 20 provides drive pulses to its outputs 20a, 20b in a time-varying fashion so that during one time period the first electromagnetic coil 22a is activated and during a second time period—typically not overlapping with the first time period—the second electromagnetic coil 22b is activated.

Sensing circuit 16 includes a light source configured to illuminate a portion of a chamber of sample holder 30 and a detector configured to detect light received from the chamber. A fibre optic may be used to illuminate the chamber and a fibre optic 17 may be used to transmit light from the chamber to the detector. The detector outputs a signal indicative of the amount of received and detected light. The response (e.g., motion) of the particle to the magnetic field changes the amount of light received by the detector. For example, the presence of the particle at a particular location of the chamber may increase (or decrease) the amount of detected light. The signal output by sensing circuit 16 changes in accord with the amount of detected light as the particle moves into and out of the particular location. Processing circuit 14 typically receives the signal from the sensing circuit.

Based on the signal from sensing circuit 16, the processing circuit can determine a property of the response of the particle to the magnetic field. In some embodiments, the sensing circuit whether the particle is motion (e.g., the circuit determines whether or not the particle is oscillating, the fact of the motion). In some embodiments, the processing circuit is configured to determine an amplitude and/or a frequency of the oscillation.

Following device turn-on as described above, the sensing circuit 16 begins to detect light from chambers 24, 25. Sample (e.g., blood) entering the chambers causes a change in the amount of detected light. Typically, sample enters the chambers at slightly different points in time even if applied to the sample strip as a single volume of sample. The device determines the difference in the amount of time required for sample to enter the chambers and, if the time difference exceeds a reference value, the device can indicate an error state (e.g., via the device display) to a user.

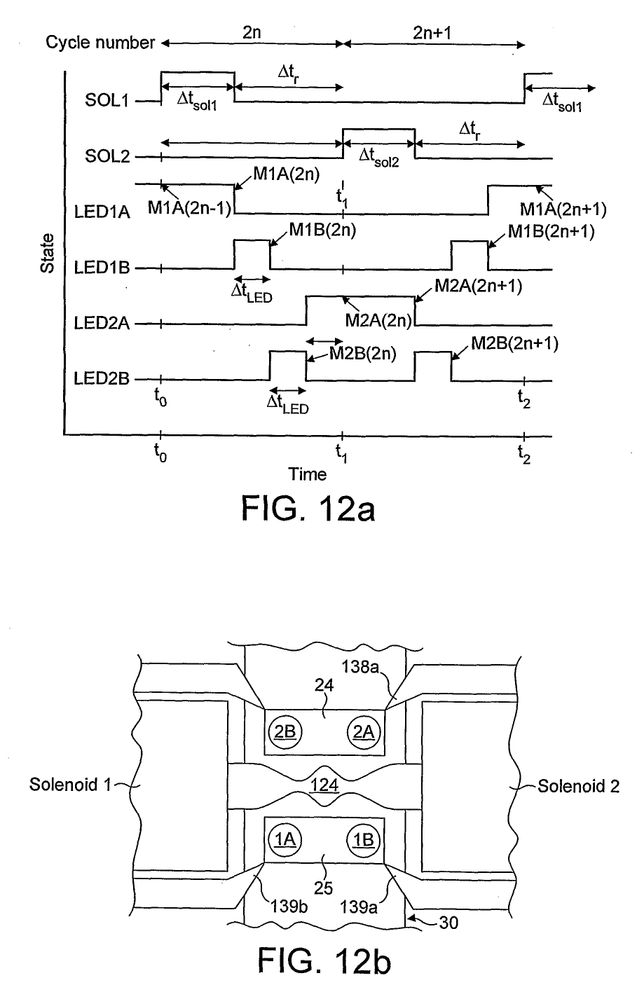

Referring to FIGS. 12a and 12b, we discuss an exemplary embodiment for timing the magnetic field to which the particle(s) are subjected and the sensor circuit for detecting a response of the particle(s) to the magnetic field. We begin with timing for the magnetic field and then discuss timing for the sense circuit.

A magnetic field timing cycle begins at t0 with the energizing of solenoid 1. In the absence of coagulated blood in the chambers of the test strip, the particle moves toward solenoid 1. In the absence of coagulated blood, the particle traverses a complete length of the chamber in about 75 ms or less (e.g., about 60 ms or less, about 50 ms or less, about 35 ms or less). In an exemplary embodiment, the particle traverses a complete length of the chamber in between about 20 ms and about 30 ms.

Solenoid 1 is energized for a period Δsol1, which typically exceeds the time required for the particle to traverse the complete length of the chamber in the absence of coagulated blood. For example, Δsol1 may be at least about 65 ms (e.g., at least about 75 ms, at least about 90 ms). The period Δsol1 may be about 350 ms or less (e.g., about 250-ms or less, about 200 or less, about 150 ms or less). In an exemplary embodiment, Δsol1 is about 100 ms.

Following period Δsol1, solenoid 1 is de-energized for a period Δtr. By de-energized it is meant that the electromagnetic field produced by solenoid 1 is reduced by at least about 50% (e.g., at least about 75%, at least about 90%, about 100%). The sum of periods Δsol1 and Δtr is typically long enough to permit the light received from each of the four chamber ends to be detected as discussed below. Typically, Δtr is at least about 75 ms (e.g., at least about 125 ms, at least about 150 ms). Period Δtr is generally about 250 ms or less (e.g., 200 ms or less). In an exemplary embodiment, period Δtr is about 150 ms. In some embodiments, period Δtr is negligible (e.g., period Δtr may not be performed).

At a time t4 given by the sum of periods Δsol 1 and Δtr (or by period Δsol1 if Δtr is not performed), solenoid 2 is energized for a period Δsol2, which is typically about the same as (e.g., the same as) Δsol1.

Following period Δsol2, solenoid 2 is de-energized for a period Δtr which may be performed (or not performed) as described following period Δsol1.

At a time t8 given by t1 plus the sum of periods Δsol2 and Δtr (or t1 plus Δsol1 if Δtr is not performed), solenoid 1 is re-energized as described for time t0. The cycle is typically repeated until the end of the analysis as discussed below.

We now turn to timing of the light illumination and optical detection.

At time t0, light source 1A (e.g., an LED) is in the on state and the remaining light sources 1B, 2A, and 2B (e.g., LED's) are in the off state. A light sensitive element receives light from a region 1A of chamber 25 that is illuminated by source 1A. The light received by the light sensitive element at time t0 is detected.

At time t1, the light sources are in the same state as at time t0. The light received by the light sensitive element at time t1 is detected. At this time the particle will have moved to the opposite end of the chamber as compared to time t0 unless coagulated blood is present.

Then, the light sources are cycled so that only light source 1B is on. The light sensitive element receives light from a region 1B of chamber 25 that is illuminated by source 1B. The light received by the light sensitive element at time t2 is detected.

Then, the light sources are cycled so that only light source 1B is on. The light sensitive element receives light from a region 1B of chamber 25 that is illuminated by source 1B. The light received by the light sensitive element at time t2 is detected.

Then, the light sources are cycled so that only light source 2B is on. The light sensitive element receives light from a region 2B of chamber 24 that is illuminated by source 2B. The light received by the light sensitive element at time t3 is detected.

Then, the light sources are cycled so that only light source 2A is on. The light sensitive element receives light from a region 2A of chamber 24 that is illuminated by source 2A. The light received by the light sensitive element at time t4 is detected. Accordingly, at time t4, light from each of the four chamber ends will have been detected with the magnetic field in the same state (times, t1, t2, t3, t4).

The light sources are maintained in the same state as at time t4 with only light source 2A is on. However, the solenoid states have switched at time t4 causing the particle to move to the opposite end of the chamber unless coagulated blood is present. The light sensitive element receives light from a region 2A of chamber 24 that is illuminated by source 2A. The light received by the light sensitive element at time t5 is detected.

Then, the light sources are cycled so that only light source 2B is on. The light sensitive element receives light from a region 2B of chamber 24 that is illuminated by source 2B. The light received by the light sensitive element at time t6 is detected.

Then, the light sources are cycled so that only light source 1B is on. The light sensitive element receives light from a region 1B of chamber 25 that is illuminated by source 1B. The light received by the light sensitive element at time t7 is detected.

Then, the light sources are cycled so that only light source 1A is on. The light sensitive element receives light from a region 1A of chamber 25 that is illuminated by source 1A. The light received by the light sensitive element at time t8 is detected. Accordingly, at time t4, light from each of the four chamber ends will have been detected with the magnetic field in the same state (times, t5, t6, t7, t8).

The foregoing cycles of switching magnetic fields and light sources is repeated until the detected light indicates a change in the movement status of the particle (e.g., a reduction or elimination of movement amplitude). For example, a failure to record a change in the amount of detected light for a period of time (e.g., at least about 1 second, at least about 2.5 seconds, at least about 5 seconds) or for a number of cycles (e.g., at least about 1 cycle, at least about 5 cycles, at least about 10 cycles, at least about 20 cycles) can be recorded as a change in the movement status.

Changes in properties of the medium in the chamber will change the response of the particle to the magnetic field. For example, an increase in viscosity can decrease the amplitude or frequency of a particle's oscillation or even stop the particle from moving altogether. For example, if a sample of blood or similar body fluid, in the chamber coagulates, then particle movement within the blood will change. For example, the frequency or amplitude of motion of the particles may change (e.g., the particle(s) may cease to move).

The processing circuit 14 includes timing circuitry which detects the time period that elapses before coagulation is sensed. This time period is used to provide an output to the display 18 in an appropriate form.

In another embodiment the sample holder 30 contains two sample chambers 24, one for a sample under test and one for a control sample. In that embodiment the connection 17 is disposed to access both of the sample chambers so that a comparison between the control and the sample under test is made, rather than an absolute time being sensed.

It will be appreciated that in other embodiments the connection 17 may not rely on optical effects but uses instead other sensing parameters. Where optical effects are used, sensing may be directly across the sample chamber in which case the optical fibre leads to a first side of the sample chamber and the sensing fibres to the other side of the sample chamber. However, it is also possible to use reflection in which case incident light and sensing of light can take place on the same side of the sample chamber.

Turning now to FIG. 2, a first embodiment of an electromagnetic device 22 will now be described.

Referring to FIG. 2, the electromagnetic device 22 has two generally cylindrical coils 122a, 122b that are disposed on respective solid-cylindrical core portions 124a, 124b of a straight elongate core member 124. The core member 124 extends beyond the first coil 122a to a first end region 124d and beyond the second coil 122b to a second end 124e. In this embodiment the coils are wound on insulating bobbins—see FIG. 3.

The coils 122a, 122b are, as shown, generally cylindrical and have a length which is around 1.3 times their external diameter.

A respective magnetic circuit portion 130a, 130b extends around the perimeter of each coil. The first magnetic circuit portion 130a extends about the first coil 122a and engages with the first end 124d of the core member 124. The second magnetic member 130b is substantially identical to the first core member 130a and is mirror-symmetrical with it about an axis X-X¹.

The first magnetic circuit member 130a has a first proximal portion 131a that extends parallel to the axis of symmetry X-X¹ from a securing location at which it is secured to the first end 124d of the core member 124. At its ends it extends via respective shoulder portions 132a, 133a into two generally straight portions 134a, 135a that extend beside the first coil 122a. At the ends of the straight tied portions 134a, 135a the first magnetic core portion 130a extends into respective converging portions 136a, 137a that extend inwardly towards the core member 124a whilst tapering towards a point. The portions 136a, 137a are bifurcated by respective slots to form spaced-apart fingers 138a, 140a; 139a, 141a.

The bifurcations allow a test strip to be engaged in the device and mean that magnetic circuit portions can be very close to sample chambers having a geometry selected for this to happen. Typically as described elsewhere, the sample chambers are spaced longitudinally apart so that when inserted into the device they are overlaid by the fingers 138a, 140a; 139a, 141a.

As mentioned above, the second magnetic circuit member is generally identical to the first magnetic circuit member in this embodiment. Other embodiments may be provided in which the magnetic circuit members are mutually different but still provide identical or near identical magnetic fields.

In this embodiment the core member 124 is in fact a single member and has, in its central area, a slot 150 passing through it, the slot being parallel-sided and the walls of the slot being parallel to the axis X-X¹. As noted above, the fingers 138a, 140a; 139a, 141a of the core portion extend towards the core member 124. In the present embodiment they extend inwardly so that the spacing between the fingers of one end portion and those of the other end portion is only slightly more than the radius of the core portion 124a. In the region of the core member 124a lying between the fingers 138a, 140a; 139a, 141a the core member narrows symmetrically on both sides to a first region 152 of minimum extent and then tapers outwardly to a central region 151 of greater extent but lesser extent than the first core portion 124a. The narrowing and out-taper forms a sloping notch.

Again the device is mirror-symmetrical about the axis X-X¹.

The view of FIG. 3 also shows one of the bobbins 105b and some of the windings 106b.

In the presently-described embodiment a single core member 124 is used. This allows the electromagnetic device 22 to be rigid so that the field cannot vary due to movements between the coils or the magnetic circuits. However, in not all embodiments is a single core member provided. For example, in some embodiments two independent electromagnets are each wound on its own core and each has its own magnetic circuit. In these embodiments, using separate magnetic cores, other mounting means are provided so as to give the desired rigidity.

In use a sample holder 30 is inserted into the slot 150 see FIG. 2/5 with the sample holder having two sample chambers 24 that extend generally in an alignment with the tips of the fingers 138a, 138b, 139a, 139b respectively, see FIG. 3.

Referring to FIG. 4, the magnetic field is shown in the first coil 122a is excited and with an iron particle 200, 201 in each of the sample chambers, the particle being at its nearest location to the fingers 138a, 139a. Also shown in FIG. 4 is the wall 170 of the sample chamber for the particle 201, the wall extending generally between the fingers 138a, 138b, 140a, 140b of the uppermost as seen in the drawing magnetic circuit members. It will be understood that the position of the wall 170 depends on the physical structure of the sample holder and the way it is located between the fingers. However, in the present embodiment the sample holder is inserted to its fullest extent, whereupon it engages and abuts not shown and the internal structure of the sample holder is such that in this disposition the wall 170 is as shown. A similar wall not shown extends between the other set of fingers in the other sample chamber; wall 171 represents the opposite wall of the first sample chamber.

The response of the particle to the magnetic field typically includes an oscillation having an amplitude and a frequency. Typically, the amplitude and/or frequency change as the physical properties (e.g., viscosity or coagulation state) of the media through which the particle moves change. Each cycle of the oscillation typically includes a motion of the particle in a first direction along a path and in a second, opposite direction along the same general path. When moving in the second opposite direction along the same general path, at least a portion (e.g., at least about 50%, at least about 75%, at least about 90%, at least about 95%) of the particle passes through the region of space swept out by the particle when moving along the path in the first direction.

Each cycle of the motion may include the particle coming to an essentially complete stop (e.g., at rest). For example, as described with respect to FIG. 12a, the temporal dependence of the electromagnetic field may include a period Δtr during which the particle is not subjected to a magnetic field sufficient to move the particle to an opposite end of the chamber even when uncoagulated blood is present in the chamber. When uncoagulated blood is present, the period for which the particle is at an essentially complete stop (e.g., at rest) is at least as long as (e.g., equal to) Δtr. The particle may come to such an essentially complete stop (e.g., for a period that is at least as long as (e.g., equal to) Δtr) at the completion of each traversal of the length of the chamber.

In some embodiments, the path traversed by the particle is defined at least in part by a wall of the chamber. Wall 170 may increase the predictability and repeatability of the path. For example, particle 201 may contact wall 170, for example, when passing in the first and second directions of a cycle of motion. When the particle has a rotationally symmetric form (e.g., as a puck or sphere) the particle may roll along the surface of wall 170. The same behaviour may exhibited by particle(s) in each chamber of the test strip.

The form of the magnetic field is typically such that there is little or no tendency for the particle 201 to be drawn away from the wall. Even if the particle is initially elsewhere in the sample chamber, the fact that the field is consistent at least in the areas of the sample chambers means the particle 201 will follow a predictable path. In the embodiment shown the force of the particle 201 is initially substantially perpendicular to the axis X-X¹; as the particle moves towards the “pulling” finger 138a, 140a the force acquires an increasing component parallel to the axis X-X¹, with the result that the particle is urged into engagement with the wall 170.

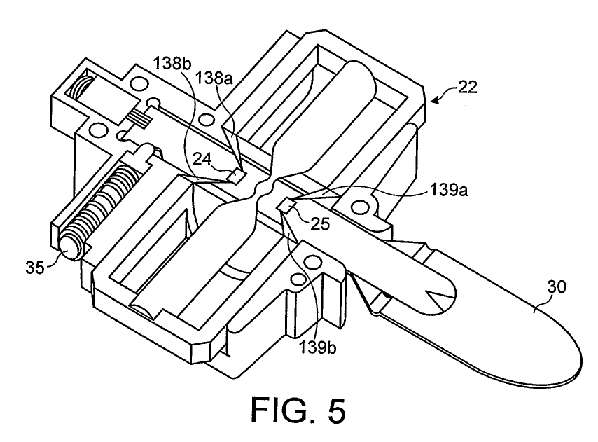

Turning now to FIG. 5, a portion of an embodiment in the sensing apparatus will now be described.

The portion as shown includes an electromagnetic device 22 shown without the coils for ease and a sample holder 30. The sample holder 30 is shown latched into position by a latching device 35. The sample holder 30 of this embodiment has two sample chambers 24, 25; when the sample holder 30 is latched, the two sample chambers 24, 25 are generally in register with the fingers 138a, 138b; 139a, 139b respectively, as discussed previously.

### General Construction

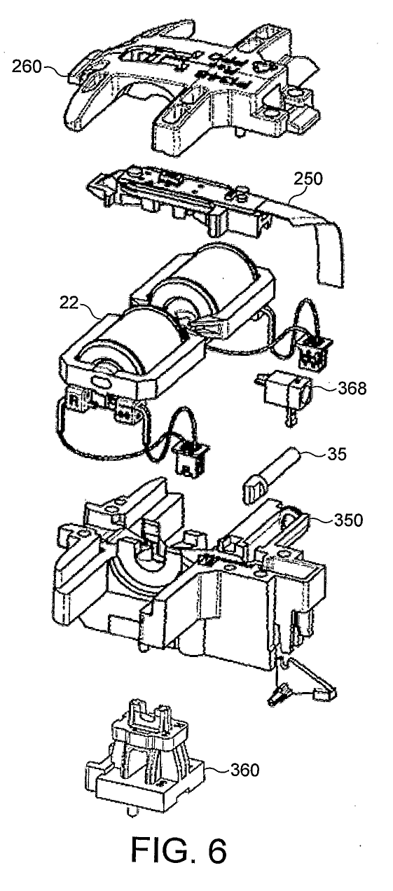

An exploded view of a more detailed arrangement of a device is shown in FIG. 6. The arrangement has a heater cap 260, a heater assembly 250, an electromagnetic assembly 22 as described above, an optical chassis 350 and a chassis plug assembly 360. The optical chassis 350 has a slider 368, a latching device 35 and a lever 367. These will be described in more detail below. FIG. 6 shows how the electromagnetic assembly 22, the heater assembly 250 and the optical sensing apparatus in the optical chassis 350 are arranged so as to fit around the sample chambers 24, 25. Heater assembly 250, electromagnetic assembly 22 and optical chassis 350 are located directly onto a device chassis. In the following, where reference is made to only one sample chamber, this shall be read as reference to either sample chamber 24, 25.

Optical chassis 350 has receiving portions for receiving and securing electromagnetic assembly 22. Heater cap 260 provides support for heater assembly 250 and also secures electromagnetic assembly to the optical chassis 350.

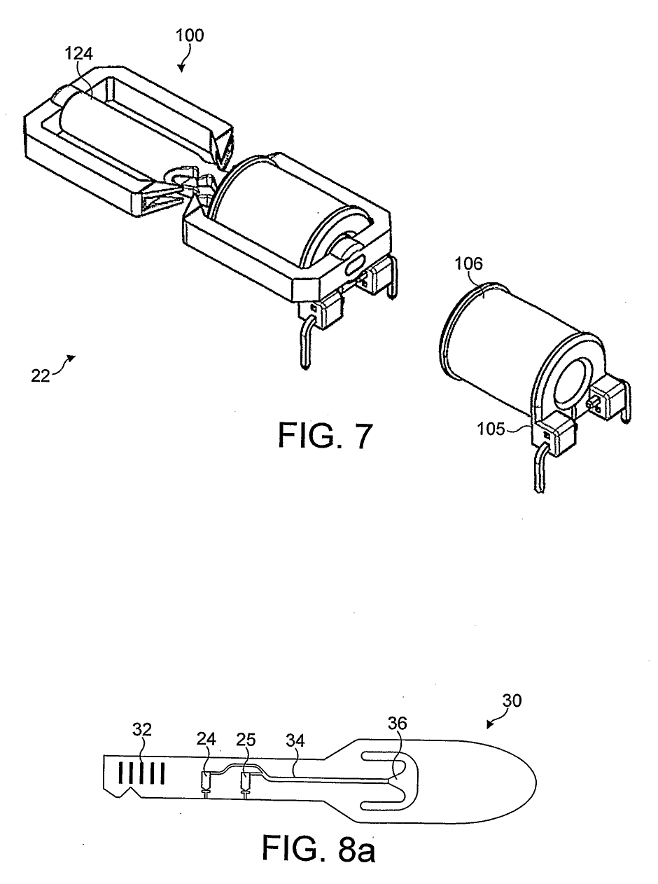

Another exploded view is shown in FIG. 7. This shows a perspective exploded view of the electromagnetic assembly 22. The electromagnetic assembly 22 comprises a core element 100 and two coils 122a, 122b. Each coil 122 comprises an insulating bobbin 105 and a wire coil 106. FIG. 7 shows only one coil 122 in place on core element 100. The same coil 122 is shown in isolation to the right of FIG. 7. Each wire coil 106 has 620 turns of wire. The wire of the wire coils 106 is 0.2 mm diameter. Each coil 106 has a resistance of 10 Ohms.

The heater carrier is positioned and located by the optical chassis 350. Accordingly, a tight tolerance can be obtained between the optical chassis 350, the electromagnetic assembly 22 and the heater assembly 250.

As discussed above, the electromagnetic assembly 22 provides a sufficiently strong and appropriately directed magnetic field to move the particle 201. Further, the magnetic field produced is substantially the same in both sample chambers 24 and 25. In addition to this, the magnetic assembly 22 allows the heater assembly 250 and the optical fibres 351 to interact with the sample chambers 24 and 25.

The core element 100 is fabricated by metal injection moulding. The core element 100 produced by metal injection moulding has a material density of 95%.

### Test Strip

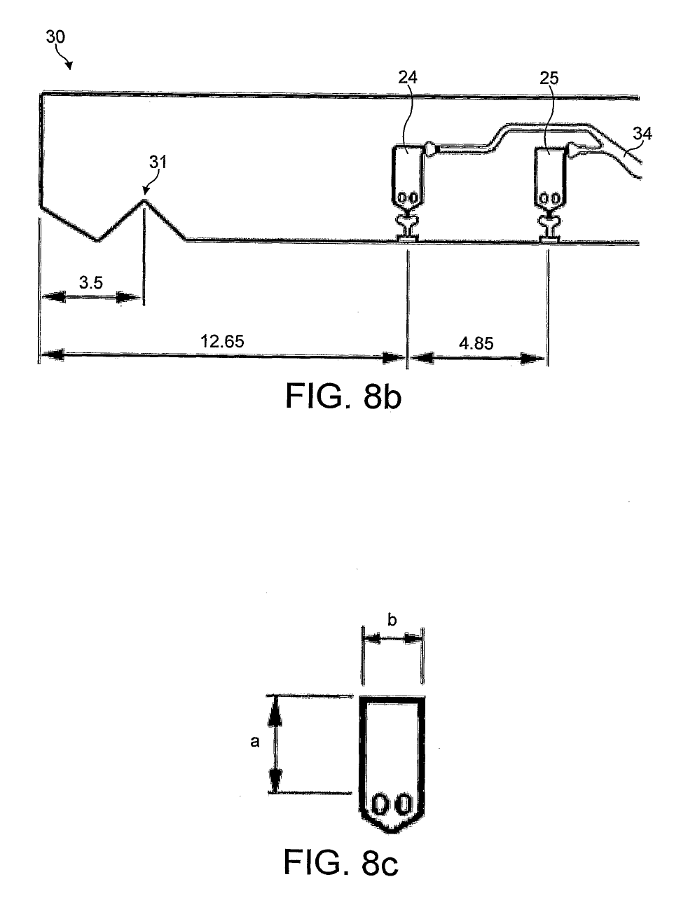

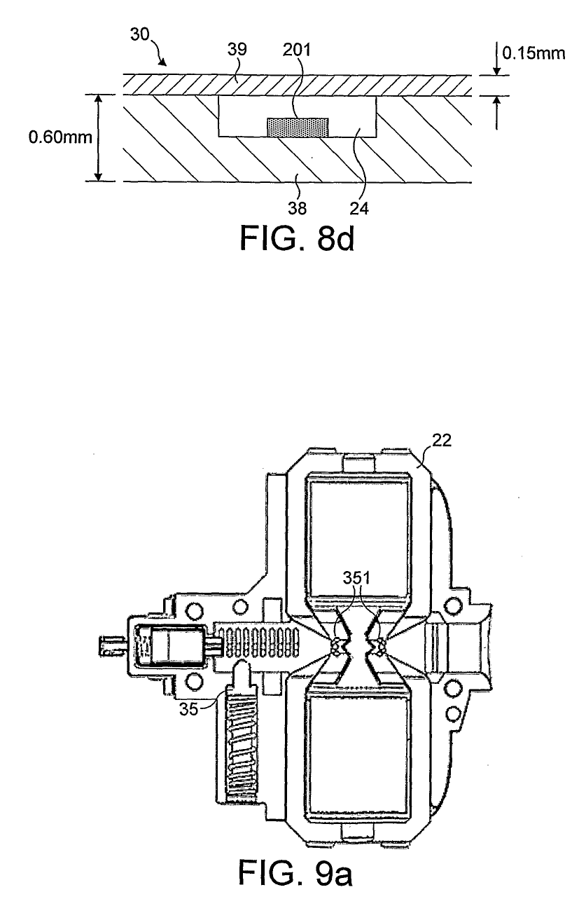

FIG. 8a shows a test strip 30 having a locating notch 31, a barcode 32, sample chambers 24, 25, micro fluidic channels 34 and a fluid entry point 36. Fluid entry point is connected to the sample chambers 24 and 25 by the micro fluidic channels 34. FIG. 8b shows an enlarged view of a portion of the test strip 30. FIG. 8c shows a sample chamber 24 of the test strip 30. The dimensions a and b are 1.6 mm and 1.0 mm respectively. FIG. 8d shows a cross section through the test strip 30. The test strip 30 is fabricated from a transparent polycarbonate substrate 38 with a layer of laminate 39 fixed to a top surface. The top surface of the substrate 38 has various fluidic details thereon. Such fluidic detail includes the sample chambers 24, 25, capillary channels, capillary valves and exhaust valves. The laminate layer 39 is fixed to the top surface of the substrate 38 so as to provide one surface of the fluidic components of the sample strip.

The test strip 30 is 5 mm wide and 48.5 mm long. A device as described herein could be made so as to operate with any sized test strip 30.

The substrate 38 of the test strip 30 is fabricated by injection moulding. The injection moulding typically incorporates micro fluidic structures such as the sample chambers and locating geometry such as locating notch 31. The device described herein can function with a test strip 30 manufactured by other means, such as, for example, lamination of a plurality of layers of material, the micro fluidic detail cut into one or more of the laminae.

Within each sample chamber 24, 25 there is provided a reagent and a particle 201. The edges of the sample chambers 24, 25 constrain the movement of the particle 201. The substrate 38 is substantially transparent, the lamina 39 is white.

In use, a test strip 30 is inserted into a test device as described above. Blood is introduced to the test strip 30 via the fluid entry point 36. Blood flows through the micro fluidic channels 34 and fills both sample chambers 24 and 25 simultaneously. As blood enters the sample chambers 24 and 25, the particle 201 is dislodged and is allowed to move freely within its sample chamber. The movement of the particle 201 is constrained by the walls of sample chambers 24 and 25. Each sample chamber 24, 25 has a predefined measure of reagent. Once the blood enters the sample chamber it reacts with the reagent and begins the coagulation process.

### Position of Fibres and Magnets

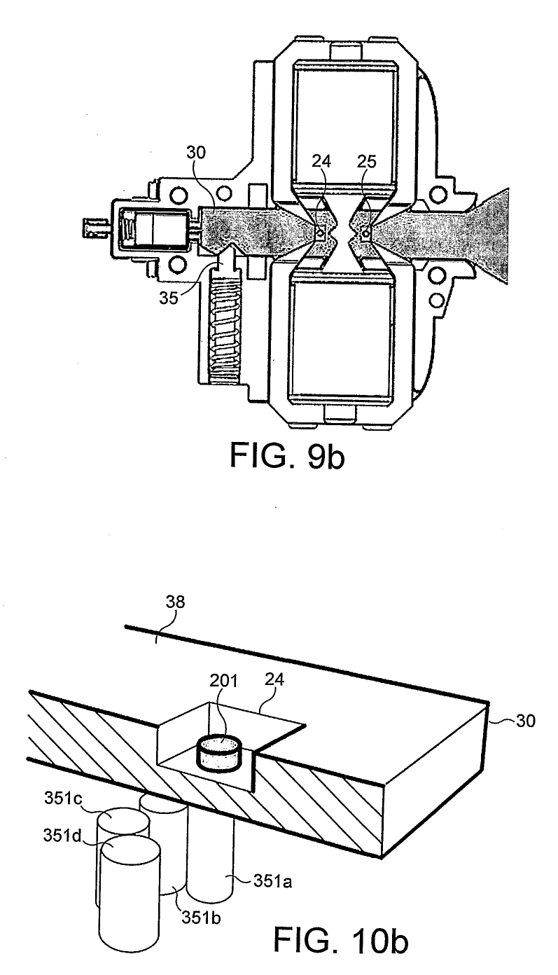

FIG. 9a shows the relative position of the electromagnetic assembly 22 and the optical fibres 351 of the optical detection means. Latching device 35 is shown for orientation. FIG. 9b shows a similar arrangement to that of FIG. 9b, but with a test strip 30 inserted. Latching device 35 is shown as engaged with locating notch 31 of test strip 30. Sample chambers 24 and 25 are positioned between the fingers of electromagnetic assembly 22.

In operation, once a test strip 30 is correctly positioned in the optical chassis 350 and the optical fibres 351, then because the electromagnetic assembly 22 is secured to the optical chassis 350, the test strip 30 is also correctly positioned relative to the electromagnetic assembly 22.

### Optical Fibres

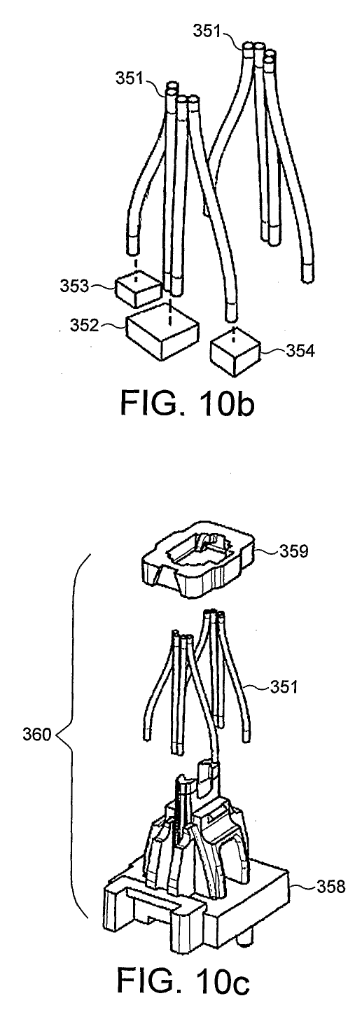

FIG. 10a is a schematic of the arrangement of the optical fibres in relation to a sample chamber 24 when a test strip 30 is inserted into the device. Sample chamber 24 in substrate 38 of test strip 30 is arranged adjacent to the optical fibres 351. FIG. 10a shows only the ends of the optical fibres 351 adjacent to a test location. FIG. 10b shows the optical fibres in isolation. Optical fibres are arranged in pairs having one emitter optical fibre and one receiver optical fibre. The test location for each sample chamber is provided with two of said pairs of optical fibres. In the arrangement shown, optical fibres 351b and 351c are arranged to transmit light from the test location for sample chamber 24 to a receiver 352. Optical fibre 351a is arranged to transmit light from an LED emitter 353 to the test location of sample chamber 24. Optical fibre 351d is arranged to transmit light from an LED emitter 354 to the test location of sample chamber 24. In this embodiment each optical fibre is 0.5 mm in diameter and 10 mm long. A symmetrical arrangement of optical fibres, LED emitters and receiver is provided in respect of the test location of sample chamber 25.

FIG. 10c is an exploded perspective view of the chassis plug assembly 360. Chassis plug assembly 360 has a Chassis plug 358, an optical retainer 359 and houses the optical fibres 351. Chassis plug 360 is located into optical chassis 350.

Each optical fibre 351 (a to h) is held in place by the chassis plug 358. In fabrication, the individual fibres are placed onto the chassis plug 358. The fibres are locked in position by the optical retainer 359. This forces the optical fibres into an appropriate shape and limits the bend radius. In the embodiment optical fibres having a core material of Polymethyl-Methacrylate Resin and a cladding material of Fluorinated Polymer are used. These optical fibres have a core refractive index of 1.49 and a numerical aperture of 0.5. Further, these optical fibres have a step index refractive profile index. The core diameter has a specification of typically 486 micrometers, with a minimum of 456 micrometers and maximum of 516 micrometers. The cladding diameter has a specification of typically 500 micrometers, with a minimum of 470 micrometers and maximum of 530 micrometers.

The chassis plug assembly 360 positions the ends of the optical fibres 351 adjacent to the receiver or emitters, directly over the respective emitter or receiver.

### Magnetic Field

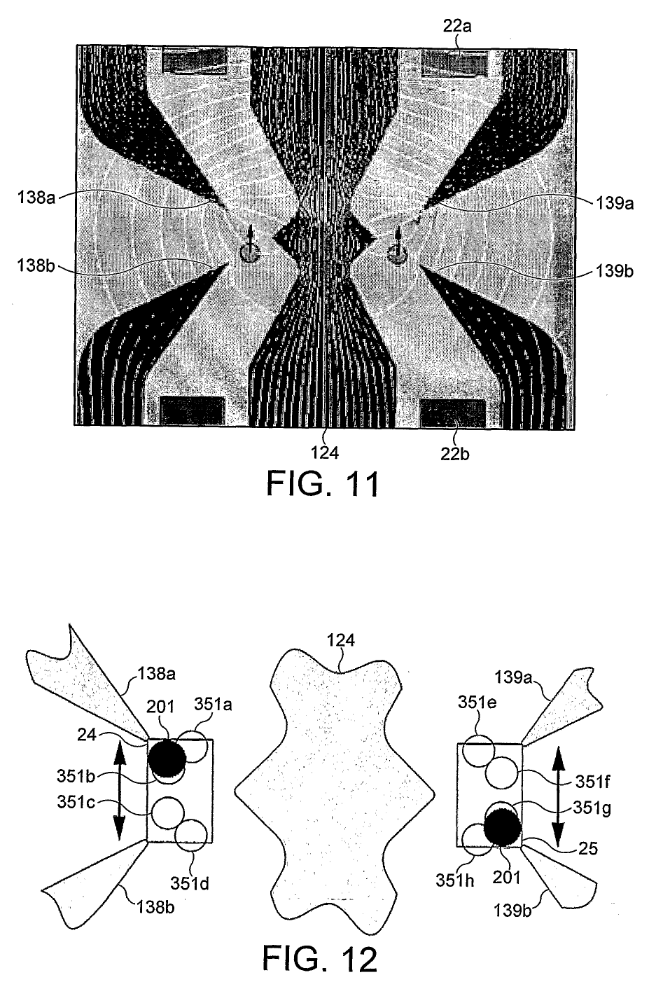

FIG. 11 illustrates the magnetic field generated by the electromagnetic assembly 22 during operation. FIG. 11 shows coil 22a energised and coil 22b not energised. FIG. 11 also shows fingers 138a, 138b, 139a, 139b of core element 100.

In operation of the electromagnetic assembly 22, the coils 106 are energised independently. A magnetic field is created between the central core 124 and fingers 138 to 141. FIG. 11 illustrates the force trajectory and direction of particle movement 201. As indicated by the small arrows, in FIG. 11 the particles 201 are subject to a force up the page. The particle 201 is moved by the magnetic field created by the electromagnetic assembly 22. Due to the configuration of the core element 100, the particle 201 is attracted to the fingers. This has the effect of moving the particles 201 along the outside edges of the sample chambers. The outside edges of the sample chambers are the edges adjacent to the fingers or core element 100.

The driving voltage to each coil determines the strength of magnetic field produced. This can be varied depending on the force that is desired to act upon the particle 201.

### Operation of the Optical System

As described above, electromagnet assembly 22 causes the particle 201 to move along a long side of its respective sample chamber 24. Optical fibres 351b and 351c which conduct light to the receiver 352 are arranged adjacent this long side of the sample chamber. FIG. 12 illustrates the start and finish position of half an oscillation of the particle 201. To the left of the diagram, sample chamber 24 is shown with a particle 201 in a start position in a corner of sample chamber adjacent 138a. To the right of the diagram, sample chamber 25 is shown with a particle 201 in a finish position in a corner of sample chamber adjacent 139b.

As the particle moves along the side of the sample chamber, optical fibres 351a and 351d, which transmit light from the LED transmitters 353 and 354 respectively remain substantially unobscured by the particle 201. This results in substantially constant illumination of the sample chamber. Light in the sample chamber is reflected by the white laminate layer 39 into the optical fibres that communicate with the receiver unless these optical fibres have their ends obscured by the particle 201.

Movement of the particle is determined by the device is determined by the interaction between the particle 201 and the optical fibres 351b and 351c that transmit light to the receiver 352.

In the start or finish position illustrated in FIG. 12, the particle 201 substantially obscures either optical fibre 351b or 351c respectively. As the particle moves along the side of the sample chamber, in a central position, the particle 201 covers the gap between optical fibres 351b and 351c. In this central position both optical fibre 351b and 351c are substantially unobscured by the particle 201.

As such, when the particle 201 is in a central position, a maximum amount of light is allowed to pass into optical fibres 351b and 351c, resulting in maximum amount of light reaching the receiver 352. When the particle 201 is in a start or a finish position, i.e. it is at one end of the sample chamber 24, a minimum amount of light is allowed to pass into optical fibres 351b and 351c, resulting in minimum amount of light reaching the receiver 352.

The particle 201 is caused to oscillate by the electromagnetic assembly 22, the oscillations of the particle 201 cause variations in the amount of light incident on the receiver 352. Processing circuit 14 uses receiver 352 to detect movement of the particle 201.

The discussion above in respect of optical fibres 351a, 351b, 351c and 351d, applies equally to optical fibres 351e, 351f, 351g and 351h as shown on the right hand side of FIG. 12. Optical fibres 351e, 351f, 351g and 351h are provided with respective LED emitters and a receiver.

In operation and with a test strip 30 inserted into the device, light is reflected by the white laminate layer 39 from one of the LED emitters to the receiver via the respective optical fibres 351. Initially, the particle is centrally located in the sample chamber, fixed to one side of the chamber by the dried reagent. When blood enters the sample chamber, the particle 201 is freed to move. Upon test start-up, a current is applied to one of the coils of the electromagnetic assembly 22, such that once the particle 201 is freed to move, it moves to one end of its sample chamber. This movement causes a decrease in transmitted light intensity. This decrease in transmitted light intensity in interpreted by the processing circuit 14 as blood entry into the sample chambers 24 and 25. In response to this detection processing circuit 14 generates a blood in signal. Because the sample chambers contain a reagent, the blood in signal also defines the start of the coagulation reaction.

The particle 201 is freed to move upon blood entering the chamber 201. The particle 201 is prevented from moving by the blood in the sample chamber clotting. Accordingly, by detecting when the particle starts moving and detecting when it stops moving, the processing circuit 14 can determine the start time and the end time for the clotting reaction. From this, the processing circuitry can determine the time taken for clotting to occur.

In this embodiment LED emitters are used. In alternative embodiments any other light source may be used. An example of such an alternative light source is a laser diode.

In the embodiment, the positional accuracy of the fibre assembly in relation to the emitter and receiver is 50 micrometers. The optical fibre surface is substantially at right angles to the optically active surface of the emitter and receiver, with an angular tolerance of +/−0.5 degrees.

### Heating

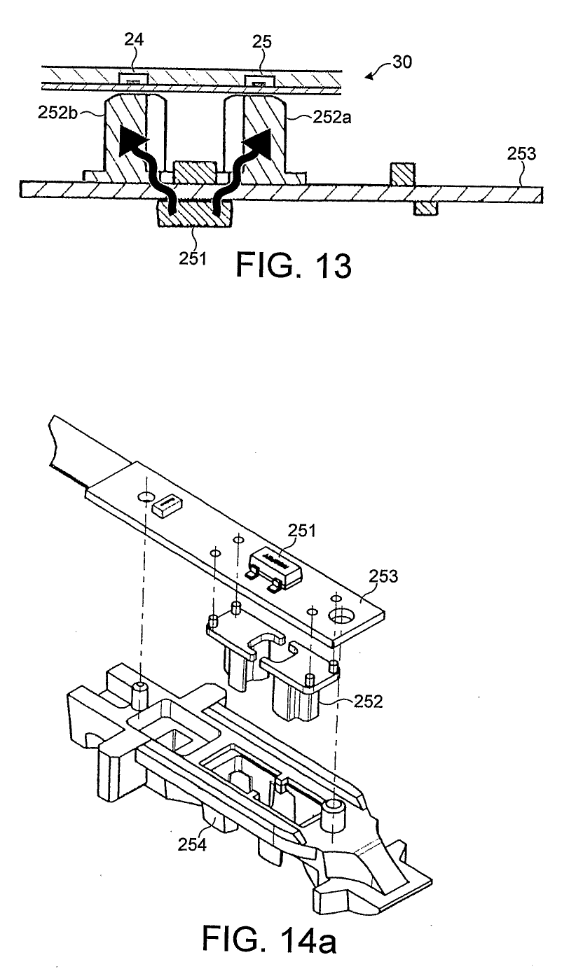

During the test procedure, the blood sample is kept at a constant temperature of 37 degrees Celsius. Heating assembly 250 heats the test strip 30 in order to maintain the temperature of the sample chambers at 37 degrees Celsius. FIG. 13 shows the heating assembly 250 adjacent to a test strip 30. The heating assembly is arranged on a side of the test strip 30 opposite to that of the optical fibres 351. Heating assembly 250 comprises a heater printed circuit board (PCB) 253 having a heat source 251 and heat transfer blocks 252a and 252b attached thereto. The heat source 251 is a MOSFET.

In operation, heat is transferred from the heat source 251 through the heat transfer blocks 252 and into the test strip 30 at the location of the sample chambers 24 and 25. The heat transfer is shown by curvy arrows in FIG. 13.

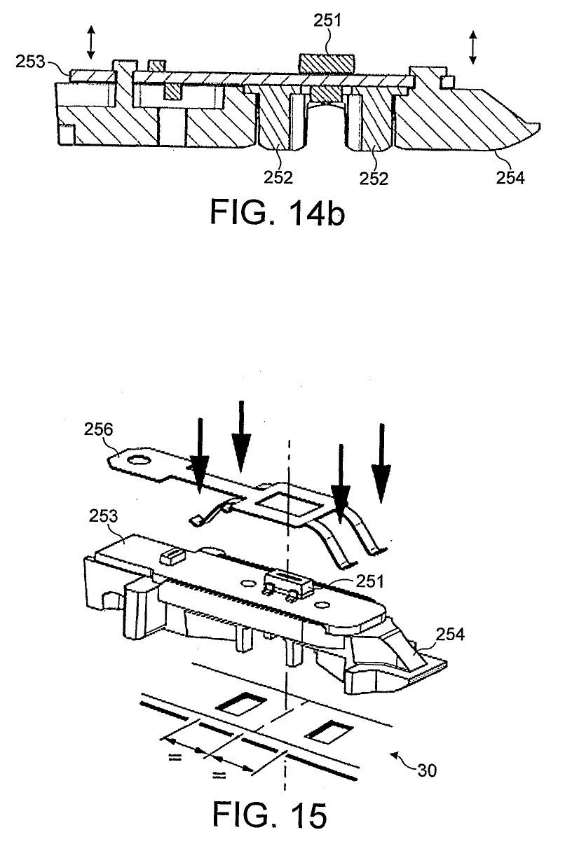

FIG. 14a is an exploded view of the heating assembly 250, showing the arrangement of the heat source 251, the heater PCB 253, the heat transfer blocks 252 and the heater carrier 254. FIG. 14b shows the elements of the heating assembly 250 and the parallel movement of the heating assembly 250 in operation.

The parallel movement of heating assembly 250 shown in FIG. 14b is provided by a biasing means. In the embodiment the biasing means is a leaf spring 256 as shown in FIG. 15. Spring 256 is arranged between heater cap 260 and the heater PCB 253. Further, the heater carrier 254 provides a rigid platform supporting the heater PCB 253. The heater carrier 254 ensures the entire assembly moves in a vertical linear movement in relation to the plane of a test strip 30.

Upon test strip 30 insertion into the device, the heater carrier 254 and the rest if the heating assembly 250 are deflected by 0.35 mm. This deflection is taken up by spring 256. Spring 256 resists this deflection and produces an opposing force which pushes heating assembly 250 and in particular heat transfer blocks 252 against the test strip 30. This opposing force is 3.61 Newtons, which allows sufficient heat conduction and an acceptable obstruction force. The obstruction force is the force applied by the heater assembly 250 opposing the insertion and removal of a test strip 30. If the obstruction force is too great, a user may not be able to properly insert or remove a test strip 30 into or form the device. In order to ensure a strip can be inserted into the device, a shallow radius of 0.8 mm is integrated into the front edge of the heater carrier. This reduces the obstruction force to an acceptable level.

The heat transfer blocks 252 protrude from the surface of the heating assembly facing the test strip 30 by a distance of 50 micrometers. This protrusion ensures good thermal contact between the heat transfer blocks 252 and the test strip 30. This protrusion produces an increase in the obstruction force, which is minimized by a small radius on the edges of the heat transfer blocks.

The biasing of the heating assembly 250 by the spring 256 results in the test strip 30 in turn being biased against the optical chassis 250. This provides good optical communication between the optical fibres and the sample chambers, and as will be discussed below, between the barcode 32 and the sensor array 351.

The thermal conductivity between the heat transfer blocks 252 and the test strip 30 is proportional to the force with which the heat transfer blocks are pressed against the test strip 30. Accordingly, the spring 256 provides a reproducible force that is substantially the same for both chambers 24 and 25. In this way the temperatures of the test chambers are substantially equal.

Two temperature sensors are provided. A first temperature sensor measures the temperature of the heat source 251. A second temperature sensor measures the ambient temperature in the region of the optical fibres 351. Both temperature readings are used in a feedback loop to regulate the amount of heat produced by heat source 251. The heat output from heat source 251 can be varied, for example, by varying the current applied to it.

The heat transfer blocks 252 have high thermal conductivity. The heat transfer blocks 252 can be made from copper by metal injection moulding. In order to reduce the thermal lag between the heat source and the test strip 30, the volume of heat transfer blocks 252 is minimized.

### Latch

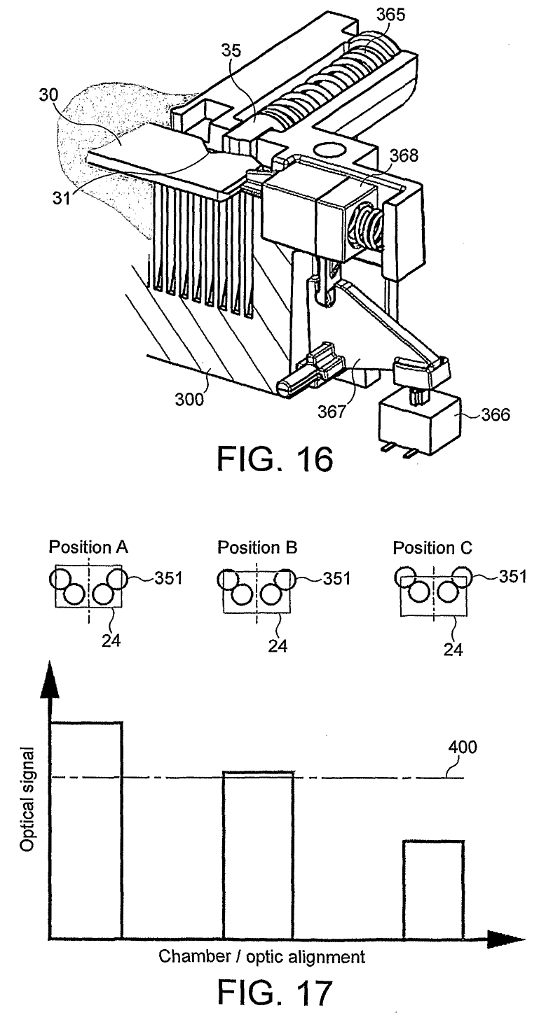

The optical chassis 350 is shown in FIG. 16 in conjunction with the latching device 35, latching device biasing means 365, insertion switch 366, lever 367 and slider 368. A portion of a test strip 30 is shown in FIG. 16 with its locating notch 31 arranged facing the latching device 35. Insertion switch 366 is depressed by lever 367 when a test strip 30 is fully inserted into the device. Insertion switch 366 is a push to make switch which communicates with a slider 368 via lever 367.

The position of insertion switch 366 indicates the positional status of the test strip 30. Activation of insertion switch 366 indicates that the test strip 30 is correctly aligned with the magnetic and optical components of the device. Further, activation of insertion switch indicates to processing circuit 14 that the test sequence can be initiated. The processing circuit 14 may initiate the test sequence by displaying an icon on the display 18.

The sample chambers 24 and 25 of the test strip 30 need to be aligned with the optical fibres 351 for proper operation of the device. This allows the device to resolve the movement of the particle 201. If the chamber deviates from exact alignment the strength of the optical signal received by receiver 352 is reduced. In particular, the difference between maximum signal strength and minimum signal strength as defined above becomes less defined. If the deviation is sufficient, the difference becomes impossible to resolve.

For the embodiment described herein, the optical levels have been found to be below an acceptable level when the deviation from exact alignment is greater than 0.15 mm. FIG. 17 shows three relative positions A, B, C of a sample chamber 24 in relation to a set of four optical fibres 351. Position A shows a sample chamber and the respective optical fibres in exact alignment. Position B shows a sample chamber and the respective optical fibres in a minimum acceptable alignment. Position C shows a sample chamber and the respective optical fibres in an incorrect alignment. FIG. 17 also shows the relative optical signal strengths generated by each of positions A, B and C. Line 400 shows the acceptable threshold level of the optical signal. Below the acceptable threshold level, the device cannot accurately determine the position of the particle 201, and so cannot function to determine the coagulation parameter of a blood sample present in test strip 30.

Typically, the positioning apparatus is accurate to within 0.15 mm.

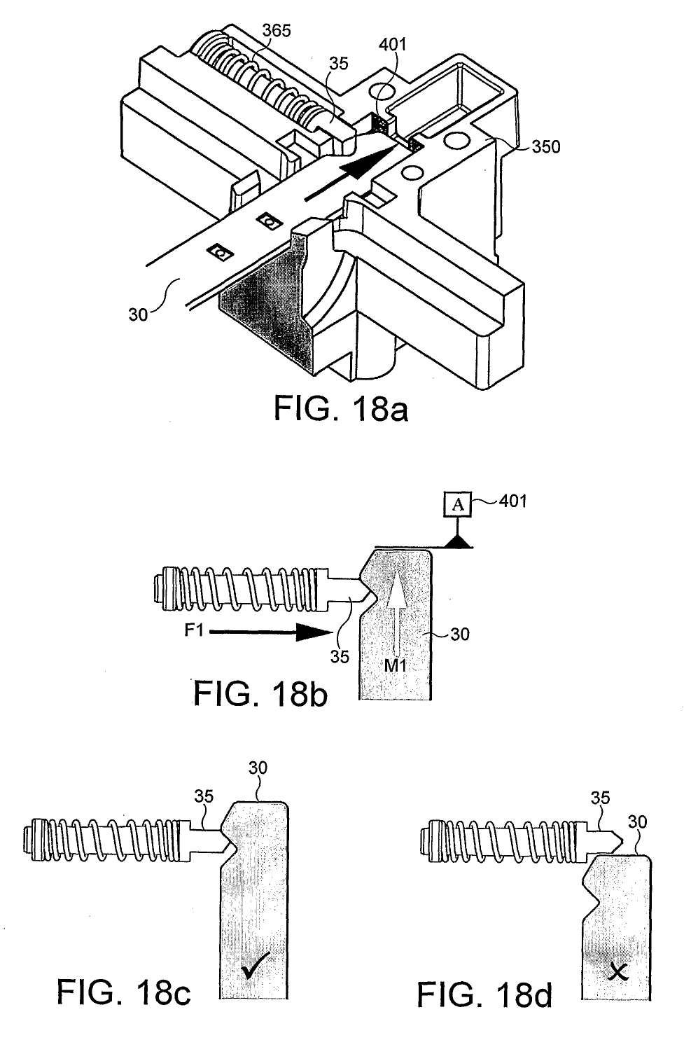

Locating notch 31 and latching device 35 are provided to correctly position test strip 30 when in use. The test strip 30 is pushed against a rear datum 401 by the interaction between locating notch 31 and latching device 35. This is illustrated in FIGS. 18a to 18d. A perspective view of a test strip 30 in position against rear datum 401 is shown in FIG. 18a. Rear datum 401 is provided by optical chassis 350. This surface to surface linear alignment ensures the test strip 30 is positioned correctly.

Optical chassis 350 carries latching device 35 which is biased towards a test strip receiving cavity of the optical chassis 350 by a biasing means 365. In this embodiment biasing means 365 is a coiled spring 365. Latching device 35 is subject to a force F1 applied by spring 365. Latching device 35 moves and is biased in a direction perpendicular to the direction of insertion of a test strip 30.

Latching device 35 thus pushes against the edge of test strip 35 with force F1 as shown in FIG. 18b. Latching device 35 applies force F1 to an angled surface of test strip 30 at locating notch 31. This interaction causes test strip 30 to push against the rear datum 401 with a force M1 as shown in FIG. 18b. Force M1 is perpendicular to F1 and in a direction of test strip insertion.

Locating notch 31 and latching device 35 thus operate to accurately position the sample chambers 24 and 25 relative to the electromagnetic assembly 22 and optical fibres 351. This positioning also brings the sample chambers into correct position relative to the heater assembly 250 and the barcode sensor array 371.

Additionally, locating notch 31 and latching device 35 provide the user with a mechanical acknowledgement that the strip is correctly located and fully inserted into the device. This also prevents the strip from falling out of the device during use. Tactile feedback is provided by the spring 365 connected to the latching device 35 being initially compressed as the tip of the test strip 30 is pushed passed the latching device 35. Once the test strip 30 is sufficiently inserted, the latching device 35 falls into locating notch 31 and applies a force on test strip 30 in the direction of M1, as described above. The user detects this force upon test strip insertion as tactile feedback.

FIGS. 18c and 18d show how the latching device 35 prevents incorrect insertion of a test strip 30. Test strip 30 has an angled end on the side of the locating notch 31 and a straight end on the opposite side. Upon correct insertion of test strip 30, as shown in FIG. 18c, the angled end pushes the latching device, compressing spring 365 until the locating notch 31 reaches the position of the latching device 35. Upon incorrect insertion of test strip 30, as shown in FIG. 18d, the straight end hits the latching device and the latching device does not move. This prevents further insertion of the test strip 30. Further, there is no tactile feedback of correct insertion as described in the preceding paragraph.

### Barcodes

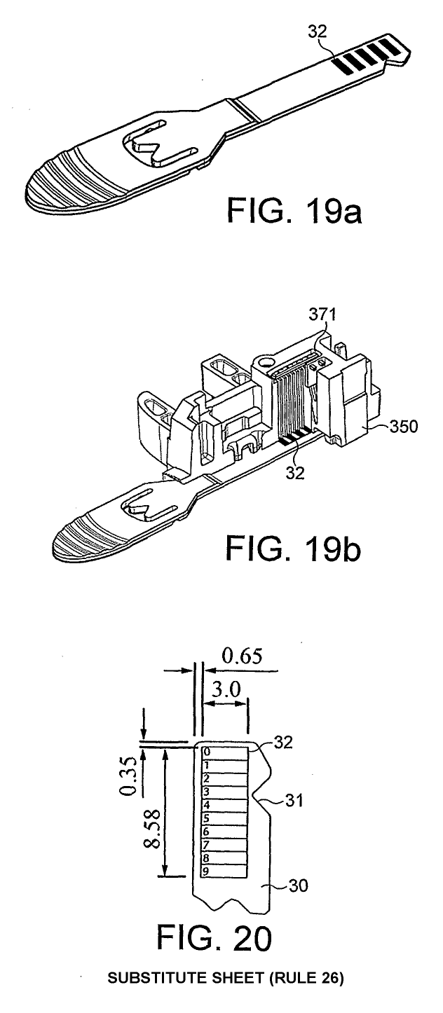

Test strip 30 has a barcode 32 as shown in FIG. 19a. Optical chassis 350 has a barcode sensor array 371 arranged such that the barcode sensor array 371 is adjacent to the barcode 32 when a test strip 30 is inserted into the device, as shown in FIG. 19b. The barcode sensor array 371 uses a reflective configuration to read the barcode 32. Upon detection of the presence of a test strip 32, the device illuminates the barcode with red light and measures the difference in reflectance and absorption of the optical bars using a linear photodiode. The linear photodiode can be a Taos array.

Each test strip 30 has a barcode 32, which contains a production batch number. The barcode geometry comprises 10 segments as shown in the enlarged view of barcode 32 in FIG. 20. The ten segments are numbered 0 to 9. The barcode 32 is 3 mm tall and 8.58 mm long. The barcode 32 is arranged 0.35 mm from the end of the test strip 30 and 0.65 mm from a side of the test strip 30 opposite the locating notch 31.

The production batch number of each test strip 30 correlates with the production batch number stored on a ROM key which can be provided with the test strips. The ROM key contains data which may be communicated to the device for storing in connection with the production batch number. The data can be batch specific information such as normalisation factors used to calculate a normalized INR, for example, from the measured coagulation time of a blood sample in the test strip. Alternatively, the data may be an expiry date, causing the device to warn the user that an inserted test strip is out of date. Alternatively still, the device may prevent operation using a test strip that is out of date (i.e. for which the expiry date has passed).

In an alternative embodiment, the windings in the coils are such that the magnetic field alternates. This causes the particle to move more smoothly. It is believed that the alternation causes reduction in the remanence of the particle to be reduced. An alternating magnetic field is achieved by having different windings in the coils, such that (looking at FIG. 3) when the coil 124 is activated a pole (N or S) is created at 139b and when coil 124a is activated the opposite pole is created at 139a (S or N). This reversal stops the particles from getting a memory effect (by constantly reversing its poles).

The above embodiment has been described in the context of a coagulation monitor. Other embodiments may have different uses and purposes.

An embodiment has now been described, along with some variants. The features of the embodiment or of the variants are not intended to limit the scope of protection.

1-47. (canceled)

48. An apparatus, comprising:
a sample strip receiving member configured to receive a sample strip comprising a chamber, the chamber comprising a magnetically susceptible particle, the chamber having a width w and a length l,
an electromagnetic field generator configured to subject the magnetically susceptible particle of the chamber of a sample strip received by the sample strip receiving member to an oscillating magnetic field, and
a detector configured to detect a response to the oscillating magnetic field of the particle of a chamber of a received sample strip, the detector comprising an optical emitter and an optical collector, the optical emitter configured to emit light into the chamber, the optical emitter having a minimum radial dimension d1, the optical collector configured to receive light from the chamber, the optical collector having a minimum radial dimension d2, wherein (a) a ratio w/d1≦3 and a ratio w/d2≦3 and/or (b) a ratio l/d1≦4.5 and a ratio l/d2≦4.5.

49. The apparatus of claim 48, wherein the optical emitter is an optical fibre and dimension d1 is the diameter of a core of the fibre at an end of the fibre through which light exits the fibre and enters the chamber and the optical collector an optical fibre and dimension d2 is the diameter of a core of the fibre through which light from the chamber enters the fibre.

50. The apparatus of claim 48, wherein dimension d1 and dimension d2 are each about 1 mm or less.

51. The apparatus of claim 50, wherein dimension d1 and dimension d2 are each about 0.75 mm to 2 mm or less.

52-53. (canceled)

54. The apparatus of claim 48, wherein the ratio w/d1≦2.25 and the ratio w/d2≦2.25.

55. The apparatus of claim 54, wherein the ratio w/d1≦2.1 and the ratio w/d2≦2.1.

56. The apparatus of claim 48, wherein w is about 0.75 mm to about 2 mm.

57-60. (canceled)

61. The apparatus of claim 48, wherein the ratio l/d1≦4.5 and the ratio l/d2≦4.5.

62. The apparatus of claim 61, wherein the ratio l/d1≦3.75 and the ratio l/d2≦3.75.

63. The apparatus of claim 48, wherein l is about 1 mm to about 3 mm.

64-67. (canceled)

68. The apparatus of claim 48 wherein the optical detector comprises a single light sensitive element configured to simultaneously receive light from each of at least two spaced apart locations of the chamber, light from at least one of the spaced apart locations being received via the optical collector.

69. The apparatus of claim 48, wherein the optical emitter is a first optical emitter, the optical collector is a first optical detector, the detector further comprises a second optical emitter and a second optical collector, the second optical emitter is configured to emit light into the chamber, the second optical emitter has a minimum radial dimension d3, the second optical collector is configured to receive light from the chamber, the second optical collector has a minimum radial dimension d4, and (a) a ratio w/d3≦3 and a ratio w/d4≦3 and/or (b) a ratio l/d3≦4.5 and a ratio l/d4≦4.5.

70. The apparatus of claim 69, wherein the optical emitter is an optical fibre and dimension d3 is the diameter of a core of the fibre at an end of the fibre through which light exits the fibre and enters the chamber and the optical collector is an optical fibre and dimension d4 is the diameter of a core of the fibre through which light from the chamber enters the fibre.

71. The apparatus of claim 69, wherein d1 and d3 are about the same and d2 and d4 are about the same.

72. The apparatus of claim 48 wherein a ratio of a minimum radial dimension of the particle to a width of the chamber is about 0.4 to about 0.9.

73-75. (canceled)

76. The apparatus of claim 48, wherein a minimum radial dimension of the particle is larger than either d1 or d2.

77. The apparatus of claim 76, wherein the minimum radial dimension of the particle is larger than either d3 or d4.

78. The apparatus of claim 69 wherein the optical detector comprises a single light sensitive element configured to simultaneously receive light from a first location of the chamber via the first optical collector and a second spaced apart location of the chamber via the second optical collector.

79-99. (canceled)
